(19) United States
(12) Patent Application Publication
(10) Pub. No.: US 2023/0244990 A1
(43) Pub. Date: Aug. 3, 2023

(54) SEMANTIC GRAPHING OF HETEROGENEOUS DOCUMENTS FOR AUTOMATED DECISION MAKING AND RESOURCE ALLOCATION USING REINFORCEMENT LEARNING

(71) Applicant: NEC Laboratories Europe GmbH, Heidelberg (DE)

(72) Inventors: Tobias Jacobs, Heidelberg (DE); Julia Gastinger, Heidelberg (DE)

(21) Appl. No.: 17/718,442

(22) Filed: Apr. 12, 2022

Related U.S. Application Data
(60) Provisional application No. 63/305,702, filed on Feb. 2, 2022.

(51) Int. Cl. G06N 20/00; G06F 11/34

(52) U.S. Cl. CPC G06N 20/00; G06F 11/3409

(57) ABSTRACT

A method for generating accurate relationships among heterogeneous documents in a semantic graph for an application includes generating a representation for each one of a plurality of heterogeneous documents contained in an expert graph having a plurality of links. A link score is computed for each of the links of at least a first one of the documents based on the representations of the documents. For the first one of the documents, other ones of the documents are selected as link targets based on the link scores using reinforcement learning. The link targets are forwarded to the application.

### CROSS-REFERENCES TO RELATED APPLICATION

Priority is claimed to U.S. Provisional Application No. 63/305,702, filed on Feb. 2, 2022, the entire disclosure of which is hereby incorporated by reference herein.

### FIELD

The present invention relates to artificial intelligence (AI) and machine learning (ML) and, in particular, to a method, system and computer-readable medium to build, maintain and improve a graph of semantic and meaningful relationships between heterogeneous documents.

### BACKGROUND

Information systems can provide a structured repository of documents, in which documents are organized and categorized by multiple criteria, so that they can be searched using several criteria. An important usage pattern of such systems is browsing and following links between semantically connected documents. Links between documents can be provided based on mutual relevance. As a first example, one document can contain a tax law, and another document can contain a complaint filed by a taxpayer. If the law is relevant for the case, this can be represented by a semantic link. As a second example, in a case management system, the decision taken for one case can be a suitable blueprint for a decision to be taken for another case. The similarity relationship between cases can be represented by a semantic link. Building and maintaining a semantic graph of heterogeneous documents present challenges.

### SUMMARY

In an embodiment, the present invention provides a method for generating accurate relationships among heterogeneous documents in a semantic graph for an application. The method includes generating a representation for each one of a plurality of heterogeneous documents contained in an expert graph having a plurality of links, computing a link score for each of the links of at least a first one of the documents based on the representations of the documents, selecting, for the first one of the documents, other ones of the documents as link targets based on the link scores using reinforcement learning, and forwarding the link targets to the application.

### BRIEF DESCRIPTION OF THE DRAWINGS

Subject matter of the present disclosure will be described in even greater detail below based on the exemplary figure. All features described and/or illustrated herein can be used alone or combined in different combinations. The features and advantages of various embodiments will become apparent by reading the following detailed description with reference to the attached drawing, which illustrates the following:

FIG. 1 illustrates a system architecture for semantic graphing of heterogeneous documents according to some embodiments of the present invention.

FIG. 2 is a flowchart illustrating a method for semantic graphing of heterogeneous documents according to some embodiments of the present invention.

### DETAILED DESCRIPTION

Embodiments of the present invention provide a method, system and computer-readable medium to build, maintain and/or improve a graph of semantic and meaningful relationships between heterogeneous documents, taking into account a library of document linking functions as well as graph browsing records. This can be achieved by a reinforcement learning module which internally maintains models to predict the relevance and explorativeness of links, updating the models from rewards generated by observing the utilization of proposed links.

Thus, embodiments of the present invention can accommodate information provided by domain experts on links between documents, while at the same time observing the browsing behavior to improve the provided links over time. By improving the accuracy of the links, and the learned graph as a whole, various potential technical applications which rely on such links, e.g., for automated decision making, allocating resources, executing actions, automatically displaying certain information or controlling system components, etc. are likewise improved in terms of accuracy and efficiency. Depending on the application, this can also results in saving physical resources, such as computational resources, of automated systems. Also, by training a document embedding function end-to-end together with a link scoring function, embodiments of the present invention provide to auto-adapt to a given library of expert linkers and enable to efficiently add new documents to the system without the need to immediately retrain. Moreover, embodiments of the present invention enable to apply links that provide a trade-off between exploration and exploitation to enhance flexibility of the application. For example, providing for explorative links for a particular application, rather than only links known to be relevant, could enable to discover meaningful relationships that were not previously known to exist for that application.

Semantic relations between pairs of documents can be provided by multiple means, such as: (1) manual specification of links by the authors of the documents (e.g., citations); (2) links computed by a function which takes all documents as input and provides links between pairs of documents as the output (see, e.g., Benedetti, F., et al., “Computing inter-document similarity with context semantic analysis,” Information Systems 80, pp. 136-147 (2019), which is hereby incorporated by reference herein); and (3) links learned through observing document access patterns and generalizing these observations into a model (see, e.g. Nugroho, F., et al., “Keywords Recommender for Scientific Papers Using Semantic Relatedness and Associative Neural Network,” TOP Conference Series: Materials Science and Engineering, Vol. 662, No. 5, TOP Publishing (2019), which is hereby incorporated by reference herein).

Embodiments of the present invention provide a method, system and computer-readable medium to build, maintain and/or improve a semantic graph between heterogeneous documents that can incorporate all three types of input means for providing the semantic relations (also referred to herein as links). The method and system can start with no ground truth about the relevance of the links, and systematically take document access patterns into account. The method and system can also automatically add the semantic relationships of new documents.

Embodiments of the present invention utilize a library of expert linkers as additional input of a document embedding component. The document embedding component uses an expert graph produced by the library of expert linkers, as well as raw document data (e.g., text), to generate more meaningful document embedding vectors. A link scoring component computes link scores and link frequencies based on the document embedding vectors. The document embedding component and the link scoring component can be trained end-to-end together, in order to auto-adapt to the given library of expert linkers. A link selector selects and applies links based on their predicted probability to be relevant, based on the link scores and the link frequencies. The link selector, as well as the document embedding component and the link scoring component, are trained using reinforcement learning. The link frequencies can be used to factor in the explorativeness of links. Links with higher frequencies are less explorative. According to some embodiments, links can be selected based on a trade-off between exploration (providing new links that have not been selected previously) and exploitation (providing links that have been selected previously). The link scores and link frequencies can be updated using the observed reward.

According to some embodiments, the document embedding vectors computed by the document embedding component can be cached and be re-used. When a significant number of new documents have been added to the system, the library of expert linkers can be applied to the new documents. Previously cached document embedding vectors can be combined with the output of the expert linkers to efficiently compute approximate embedding vectors of newly added documents. Thus, new documents can be accommodated in the system without the need to immediately re-train the system.

In an embodiment, the present invention provides a method for generating accurate relationships among heterogeneous documents in a semantic graph for an application. The method includes generating a representation for each one of a plurality of heterogeneous documents contained in an expert graph having a plurality of links, computing a link score for each of the links of at least a first one of the documents based on the representations of the documents, selecting, for the first one of the documents, other ones of the documents as link targets based on the link scores using reinforcement learning, and forwarding the link targets to the application.

Aspect (1): In an aspect (1), the present invention provides a method for generating accurate relationships among heterogeneous documents in a semantic graph for an application. The method includes generating a representation for each one of a plurality of heterogeneous documents contained in an expert graph having a plurality of links, and computing a link score for each of the links of at least a first one of the documents based on the representations of the documents. The method further includes selecting, for the first one of the documents, other ones of the documents as link targets based on the link scores using reinforcement learning, and forwarding the link targets to the application.

Aspect (2): In an aspect (2), f the present invention provides the method according to the aspect (1), wherein the expert graph is generated by applying a library of linking functions to the documents. Each link links a source document to a target document according to the linking functions. Generating the representation for each one of the documents is performed by a document embedding model that includes a set of first parameters and is trained to generate the representations as an n-dimensional vector of real numbers based on raw data or text of the respective document, the expert graph and the set of first parameters.

Aspect (3): In an aspect (3), the present invention provides the method according to the aspect (2), wherein the link scores are computed by a link scoring model that includes a set of second parameters. The link targets are selected using a reinforcement learning module that is trained using reinforcement learning to select the link targets based on the link scores and link frequency such that the selected link targets are explorative and exploitable.

Aspect (4): In an aspect (4), the present invention provides the method according to the aspect (3), wherein the aspect (4) further includes tracking browsing history with regard to the link targets, and training the document embedding model and the link scoring model using the browsing history as training data, to optimize the set of first parameters of the document embedding model and the set of second parameters of the link scoring model.

Aspect (5): In an aspect (5), the present invention provides the method according to the aspect (4), wherein a reward is computed based on whether a respective target link is selected or ignored according to the browsing history. The reward is used to train the document embedding model and the link scoring model.

Aspect (6): In an aspect (6), the present invention provides the method according to the aspect (4), wherein the document embedding model is a graph convolutional network (GCN).

Aspect (7): In an aspect (7), the present invention provides the method according to the aspect (6), wherein the GCN can include a bottom layer and one or more higher layers. For the bottom layer, an initial embedding vector is computed for each respective document using a parameterized embedding function. For each higher layer, a next layer embedding vector is computed for each respective document by aggregating over a lower layer embedding vectors of neighboring documents in the expert graph.

Aspect (8): In an aspect (8), the present invention provides the method according to the aspect (7), wherein aggregating over the lower layer embedding vectors can include aggregating over the lower layer embedding vectors of neighboring documents for each respective linking function, and aggregating over all linking functions in the library of linking functions.

Aspect (9): In an aspect (9), the present invention provides the method according to the aspect (4), wherein the link scoring model is a neural network.

Aspect (10): In an aspect (10), the present invention provides the method according to the aspect (1), wherein the aspect (10) further includes computing a respective link frequency for each respective link. The link targets are selected further based on the link frequencies in addition to the link scores.

Aspect (11): In an aspect (11), the present invention provides the method according to the aspect (10), wherein each link score indicates a degree of relevance of the first one of the documents and a respective link target, and each link frequency indicates a frequency of the respective link target being suggested.

Aspect (12): In an aspect (12), the present invention provides the method according to the aspect (11), wherein the link targets are selected by optimizing a function that is proportional to the link score and inversely proportional to the link frequency.

Aspect (13): In an aspect (13), the present invention provides the method according to the aspect (1), wherein the aspect (13) further includes accommodating a new document by applying the expert linking functions to the new document to extract new links between the new document and the documents, and generating a new representation for the new document based on the representations of the documents that are stored in cache.

Aspect (14): In an aspect (14), the present invention provides a system for generating accurate relationships among heterogeneous documents in a semantic graph for an application is provided. The system includes one or more hardware processors which, alone or in combination, are configured to provide for execution of the following steps: generating a representation for each one of a plurality of heterogeneous documents contained in an expert graph having a plurality of links, computing a link score for each of the links of at least a first one of the documents based on the representations of the documents, selecting, for the first one of the documents, other ones of the documents as link targets based on the link scores using reinforcement learning, and forwarding the link targets to the application.

Aspect (15): in an aspect (15), the present invention provides a tangible, non-transitory computer-readable medium having instructions thereon. Upon execution by one or more processors, alone or in combination, the instructions provide for execution of a method comprising: generating a representation for each one of a plurality of heterogeneous documents contained in an expert graph having a plurality of links, computing a link score for each of the links of at least a first one of the documents based on the representations of the documents, selecting, for the first one of the documents, other ones of the documents as link targets based on the link scores using reinforcement learning, and forwarding the link targets to the application.

### System Architecture

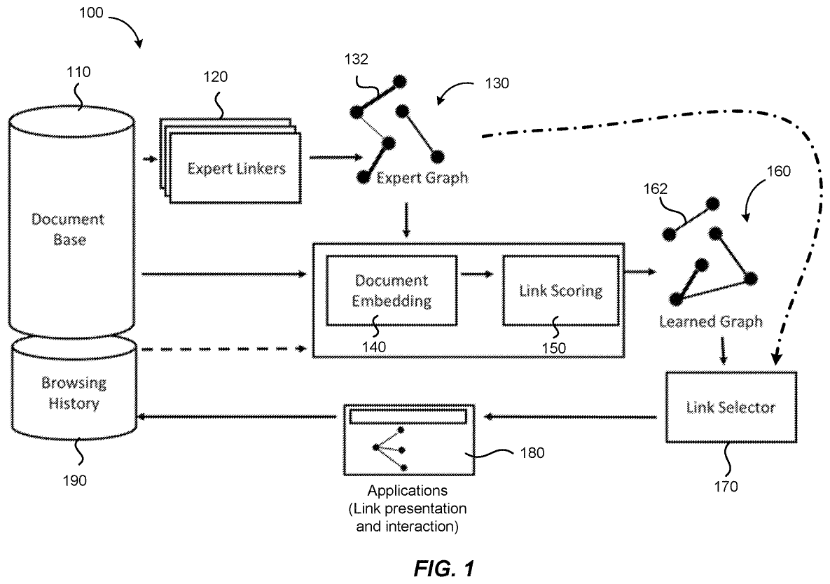

FIG. 1 illustrates a simplified block diagram of a system 100 for building and maintaining a semantic graph between heterogeneous documents according to some embodiments.

The system 100 can include a document base 110. The document base 110 can be a database that contains a plurality of documents. The documents can be of different types, e.g., text documents, audio documents, videos and images, structured data (e.g. XML documents, relational database entries, etc.), and the like.

The system 100 can also include a library 120 of document linking functions (also refereed herein as “linking functions” or “expert linkers”). The expert linkers can be utilized to extract initial links between the documents. Each expert linker can be a computer-implemented function. The input to each expert linker can be (a) a source document, and (b) a set of potential target documents. The output of each respective expert linker can be a subset of target documents selected by the respective expert linker among the set of potential target documents. In some embodiments, each expert linker can provide a numerical link strength for each selected target document, indicating a degree of relevance. For example, a higher numerical value can indicate a stronger relevance between the source document and a target document. In an embodiment, the library 120 can include different expert linkers for different types of documents. Over the lifetime of the system 100, various expert linkers can be added and maintained. The expert linkers can be reusable across different instantiations of the system 100 (e.g., when similar document types are used across different instantiations).

Various types of expert linkers can extract links between documents in various ways. For example, one expert linker can extract links between documents by parsing references provided inside the documents. For instance, if document A refers to document B, a link between A and B can be extracted. As another example, another expert linker can extract links between documents based on similarity. For instance, a similarity metric (e.g., words in common) can be applied to extract links between documents. As a further example, another expert linker can extract links between individual messages of a single communication thread. In the discussion below, the assembly of expert linkers is denoted as X, and each individual expert linker is denoted as x.

The union of all links between the documents as provided by the library 120 of expert links X can be referred to as an expert graph 130. In the expert graph 130, each link 132 can be an ordered triple (u, x, v), where u represents the source node (e.g., the source document), v represents the target node (e.g., the target document), and x E X represents the particular expert linker which has provided the link 132.

### Document Embedding Component

The system 100 can also include a document embedding component 140 and a link scoring component 150. The document embedding component 140 can be configured to compute, for each document, an n-dimensional vector of real numbers. The n-dimensional vector can be herein referred to as the document embedding vector. The document embedding component 140 can utilize a computer-implemented function for evaluating the n-dimensional vector. The document embedding component 140 can be implemented as a first machine learning model, referred to herein as the document embedding model. The input to the document embedding model can include, for example: (1) the raw data of each document, (2) the expert graph 130 (generated by the library of expert linkers 120), and (3) a set of model parameters κ.

According to some embodiments, the document embedding model can be a graph convolutional network (GCN, e.g., RGCN and REGCN) or other types of neural network that includes a plurality of layers. The bottom layer (layer 0) can include p nodes (e.g., one node each document). The values for the p nodes can be computed based on the raw data of each individual document. For example, parameterized embedding functions (e.g., next sentence prediction or NSP) can be used for text data. In each higher-layer (which also hasp nodes), document embeddings (e.g., layer i+1) can be computed by aggregating over lower-layer embeddings (e.g., layer i) of the neighbors of each document in the expert graph 130.

In some embodiments, aggregation over neighbors can be computed separately for each expert linking function x E X. For each expert linking function x, the aggregated neighbor embeddings can be passed through an expert-specific linear function (e.g., multiplied by a matrix Wₓ), and the result can be optionally passed through a nonlinear activation function. At each node, the results of the neighbor aggregations are aggregated over the set of all expert linking functions X to obtain the final node embedding of layer i+1. Once the document embedding model has been trained (as discussed below), the embedding vectors of the documents at all embedding layers can be stored for later re-use (see discussion of accommodation of new documents below).

### Link Scoring Component

The link scoring component 150 can be configured to, for a given input document (link source), compute link scores for all other documents (link targets). A link score can represent the relevance of a link target with respect to the link source. For example, a higher score can translate to a higher relevance. According to some embodiments, the link scoring component 150 can utilize a computer-implemented parameterized function for evaluating the link scores. For example, cosine similarity function, Euclidean distance, and the like, can be used. Cosine similarity is a measure of similarity between two vectors in an inner product space. The cosine similarity is defined as the cosine of the angle between the two vectors, that is, the dot product of the vectors divided by the product of their lengths. The Euclidean distance between two points in Euclidean space is the length of a line segment between the two points.

The input to the parameterized function can include the document embedding vectors provided by the document embedding component 140, and a set of model parameters δ. A link scoring for two documents dᵢ, dⱼ can be expressed as:

LinkScore(dᵢ, dⱼ)=ƒ_{d}(emb(dᵢ), emb(dⱼ), δ),

where emb(d) is the document embedding vector for a document d.

According to some embodiments, the link scoring component 150 can be further configured to compute a link frequency between each pair of documents dᵢ, dⱼ expressed as:

LinkFreq(dᵢ, dⱼ)=g_{d}(emb(dᵢ), emb(dⱼ), δ)

The link frequency provides an estimation of how frequently the link (or similar links) have been proposed in the past. The model parameters δ can be initialized randomly, and can be updated as part of the update procedure of the reinforcement learning module discussed below.

In some embodiments, the link scoring component 150 can be implemented as a second machine learning model, referred to herein as the link scoring model. The link scoring model can include a neural network. The input to the neural network can be the document embedding vectors of two documents emb(dᵢ) and emb(dⱼ). The output of the neural network can be a LinkScore and a LinkFreq. The neural network can be implemented by connecting each input neuron with each neuron of a hidden layer. Then, each neuron of the hidden layer is connected to each of the two output neurons (the LinkScore and the LinkFreq).

According to some embodiments, the document embedding model and the link scoring model can be trained end-to-end together, in order to optimize the two sets of model parameters κ and δ. After initial training against the browsing history (to be discussed below), the set of model parameters κ of the document embedding component 140 can remain fixed. When new expert linkers are added to the library 120, the document embedding model can be re-trained. The computed n-dimensional vectors of the documents can also be cached. The output of the document embedding component 140 and the link scoring component 150 is a learned graph 160.

### Link Selector

The system 100 can further include a link selector 170. According to some embodiments, the link selector 170 uses principles of reinforcement learning to select, for a given document, a set of relevant other documents as link targets. The selected link targets can be sent to an application 180 (e.g., a document browser operated by users). The link selector 170 is herein referred to as a reinforcement learning module 170. The reinforcement learning module 170 can be configured to, for each document, keep track of the previously selected link targets. The state of the reinforcement learning module 170 can be the set of document embedding vectors generated by the document embedding component 140. The reinforcement learning module 170 can decide which link to propose to the application(s) 180 based on the link scores and the link frequencies generated by the link scoring component 150. In an exemplary embodiment, given n potential links (d, d₁), . . . (d, dₙ), the link selector 170 can propose the document dᵢ that maximizes the following function:

LinkScore(d₁, dᵢ)+C/(1+LinkFreq(d, dᵢ)),

where C is a constant representing an exploration bonus.

At the application(s) 180, the selected link targets (e.g., 182a, 182b, and 182c) can be presented to user(s). Reward can be computed based on the user interactions with the selected link targets. For example, if a user selects the link target 182a, a high reward for the link target 182a can be assigned; conversely, if the user ignores the link target 182b, a low reward for the link target 182b can be assigned. In some embodiments, a user may be requested to provide feedback (e.g., “not useful,” “medium useful,” “useful,) or “very useful”) after inspecting a link target.

When a link (d, dᵢ) has been proposed and a reward r has been collected, the set of parameters δ of the link scoring component 150 can be updated. In an embodiment, the new input:output sample (d, dᵢ):r can be used to improve the output of LinkScore(d, dᵢ). Similarly, the input:output sample (d, dᵢ):m, where m is the total number of times the link (d, dᵢ) has been proposed previously, can be used to improve the output of LinkFreq(d, dᵢ). After the update, the link scoring component 150 would be able to predict the links similar to (d, dᵢ) more accurately. In addition, due to the increased frequency, the exploration bonus C of such links will be lower. In an embodiment, the neural network, which implements the LinkScore and the LinkFreq functions, is updated by computing a gradient of the squared error between the network outputs and the true values r and m, and updating the network parameters δ by following the gradient by a constant step size of E.

The system 100 can further include a browsing history database 190. User interactions with the links (e.g., 182a, 182b, and 182c presented to the applications 180), such as selected links and forwarded links, can be recorded and stored in the browsing history database 190. This data can be used as training data to update the model parameters κ and δ of the document embedding component 140 and the link scoring component 150, as discussed further below.

### System Initialization and Model Training

Both the document embedding component 140 and the link scoring component 150 contain model parameters that need to be trained. For system initialization, when the browsing history database 190 is initially empty, the model parameters κ and δ of the document embedding component 140 and the link scoring component 150 are not trained yet. In this case, the expert graph 130 can be used as the direct input to the link selector module 170, as indicated by the dot-dashed line. The document embedding component 140 and the link scoring component 150 are bypassed at system initialization.

According to an embodiment, for model training, the document embedding component 140 and the link scoring component 150 can be trained together in an end-to-end fashion. The training data set can be the labeled data provided by the browsing history database 190. The training can use techniques such as stochastic gradient descent with gradient backpropagation and the like. The training can be repeated in regular time intervals, so that new data can be taken into account (e.g., new documents, additional data in the browsing history database, and the like).

### Accommodation of New Documents

When new documents are added to the document base 110, embodiments of the present invention provide a computationally efficient procedure for preliminary accommodation of a new document, without re-training any model parameters. In an embodiment, the procedure can include the following steps. First, the expert linkers in the library 120 can be used to compute a neighborhood of the new document in the expert graph 130. For example, links between the new document and the existing documents in the document base 110 can be computed using the expert linkers. Next, an embedding vector for the new document can be computed using the document embedding component 140. In an embodiment, the model (e.g., a GCN) in the document embedding component 140 can compute the embedding vector of the new document by aggregating previously stored embedding vectors of the neighboring documents in the expert graph 130. The embedding vector of the new document, together with the embedding vectors of the existing documents, can then be input into the link scoring component 150 for evaluating link scores and link frequencies. Thus, new documents can be preliminarily accommodated without re-training the model of the document embedding component 140 and the model of the link scoring component 150.

According to some embodiments, the model of the document embedding component 140 and the model of the link scoring component 150 can be re-trained from scratch from time to time (e.g., after a certain number of new documents have been added), so that the new documents are fully accommodated.

Some exemplary applications of the system 100 are discussed below.

### Example Application 1: Job Center—Intelligent Assignment and Routing

The system 100 can be used for intelligent assignment and routing at a job center. Caseworkers in a job center can be tasked to help unemployed people find employment. There may be needs to assign job seekers to activities such as job training or some other integration program, so as to increase their chances of getting jobs. For such applications, the documents in the document base 110 can include documents relating to the job market (e.g., available positions, available trainings, associated job requirements, and the like), documents relating to the job seekers (e.g., job applications, which can include their qualifications, skills, work experience, and interests, and the like), and documents relating to available caseworkers (which can include their qualifications, interests, and the like). These documents can be stored in a database at the job center.

The system 100 can be used to build a learned graph 160 for all available documents. The learned graph 160 can provide links between job seekers and available jobs, and/or between job seekers and available trainings, and/or between job seekers and their qualifications and interests, and/or between job seekers and available caseworkers. The link selector 170 can select one or more links, such as matches between job opportunities and job seekers, matches between caseworkers and trainings, and the like. The selected links can be presented to a job seeker and/or a caseworker. In some embodiments, as integrated in the system for action recommendation, an action can be automatically performed based on the predicted links, such as inviting the job seeker to a training for a domain with a promising employment perspective. The link selector module 170 and the models of the document embedding component 140 and the link scoring component 150 can be trained based on the feedback of the job seekers and caseworkers.

Thus, the system 100 can, for example, be used for intelligently reserving seats in training classes (which can be in-person or virtual), and/or recommending job seekers to suitable employers. The system 100 can also be used as part of an intelligent call routing system, which automatically connects job seekers directly to the most appropriate agent (e.g., for a predicted, most fitting future domain) who is available, or assigns the person to a waiting list. The system 100 can also be used for advertising on digital advertising panel (screens) to promote trainings to job seekers, automatically creating and adapting job advertisements for open positions based on the available candidates, creating automated reservations for resources (e.g., driving license simulation rooms), and the like.

### Example Application 2: Tax Department

Tax departments may need to perform fraud detection, make decisions regarding tax calculation, and handle complaints from taxpayers. The system 100 can be used to help with those tasks. In such cases, the document base 110 can be a database that includes tax declarations, citizen information, communication log with taxpayers, tax laws, and the like. The system 100 can build a learned graph 160 that provides links between tax declarations and applicable laws, links between complaints and tax declarations, and similarity links between different tax declarations, and the like. Such links can assist caseworkers in fraud detection, matching incoming messages to tax cases, and complaint handling.

For example, files linked with a document currently being processed by a caseworker can be pre-fetched on a local computer. As another example, the links can facilitate auto-assignment of cases to caseworkers based on their expertise of similar cases, as well as pre-fetching the relevant documents. As a further example, the links can help automatic generate and send messages to taxpayers about the status of their requests.

### Example Application 3: Supermarket—Intelligent Advertisement System

It may be desirable that the inventory in a supermarket (available products) match the demand of customers. For example, it may be advantageous to make sure that food products are sold before they expire or are spoiled, so that food waste can be avoided. The system 100 can help with this need. In such cases, the document base 110 can be a database maintained by the supermarket, and can include sales history for various products, product information including categories and prices, digital advertisements (e.g. panels, apps), visitor history of the supermarket, and the like. The learned graph 160 can provide links between potential customers, advertisements (on different devices), and products, taking into account the relations between products, locations, customer context information (e.g., age and number of people at the train at certain hours), advertisement devices (e.g., smartphones, panels in supermarket, panels in a train), context information (e.g., public holidays, events, seasons), and the like.

The link selector 170 can provide the relevant links (e.g., the top 3 most relevant links) to be presented to an application (e.g., a shopping app). In an embodiment, as integrated in a system for action recommendation, an action can be selected based on the predicted links (e.g., advertise product x at train z). The link selector module 170 and the models of the document embedding component 140 and the link scoring component 150 can be trained based on the feedback of the customers (e.g., clicks on an advertisement) and sales history.

Thus, the system 100 can help automated adaptation of advertising on digital advertising panel (screens) to promote products of interest to match demand and supply, automated personalized advertisements in apps on smartphones, automated adaption of advertising on public transport screens, and the like.

### Example Application 4: Industry—Automatic Configuration of Production Environment

In an exemplary embodiment, the system 100 can be used for automatic configuration of a production environment in industrial applications. There is a trend nowadays towards high levels of product customization. For example, manufacturing equipment (e.g., machines, assembly lines, robots) may need to be configured to meet the demands of the desired product specifications. In addition, there may be a need for good resource planning in order to maximize the utilization ratio of the available equipment.

For such applications, the documents in the document base 110 can include descriptions of machines and other equipment, including their capabilities (e.g., in the form of text data and/or structured text data), specifications of product variants (e.g., in the form of structured text data), and descriptions of manufacturing processes for different product variants.

According to some embodiments, the expert linkers in the library 120 can be applied to documents in the document base 110 to perform a first matching between manufacturing processes and suitable equipment, and between processes and product variant specifications. The results of the first matching can form the expert graph 130, which can be input into the document embedding component 140 and the link scoring component 150. The links 162 in the learned graph 160 produced by the document embedding component 140 and the link scoring component 150 can be executed by configuring machines and attempting to produce the product variant. In some embodiments, the initial production can be performed in a simulator.

The feedback from the production (e.g., product failure rate) can be fed back to the system 100 for improving the links 162. After the link selector module 170 and the models of the document embedding component 140 and the link scoring component 150 are trained using the feedback data, the final links 162 in the learned graph can match production equipment with the product specifications, which can be used for machine configuration, and/or as input to the resource planner. Thus, the system 100 can facilitate manufacturing of the product variants with the right equipment in a resource-efficient manner.

### Example Application 5: Biomedicine—Data-supported Diagnosis and Treatment Analysis

In an exemplary embodiment, the system 100 can be used for diagnoses and treatment of diseases. Diagnoses of causes of patient symptoms and consideration of possible treatments, along with assessment of potential risks connected with the treatment, can be a highly data-intensive process. For such applications, the documents in the document base 110 can include the health records of patients, descriptions of diseases, including their causes, symptoms, and treatments with their effectiveness as well as their risks and side-effects.

According to some embodiments, the expert linkers in the library 120 can be applied to documents in the document base 110 to provide links between diseases and treatments based on historical records, between risks of treatments and individual risk factors of patients. The final links 162 in the learned graph 160 can provide information about possible diagnoses, possible treatments, and/or risks associated with selected treatments. The link selector 170 can provide suggested diagnosis and treatments. The feedback from the treatments and/or medication, such as effectiveness and side effects, can be used to improve the quality of the links. Thus, adaptations of treatments (e.g., aborting or changing treatments), and/or adaptations of doses of medication can be made.

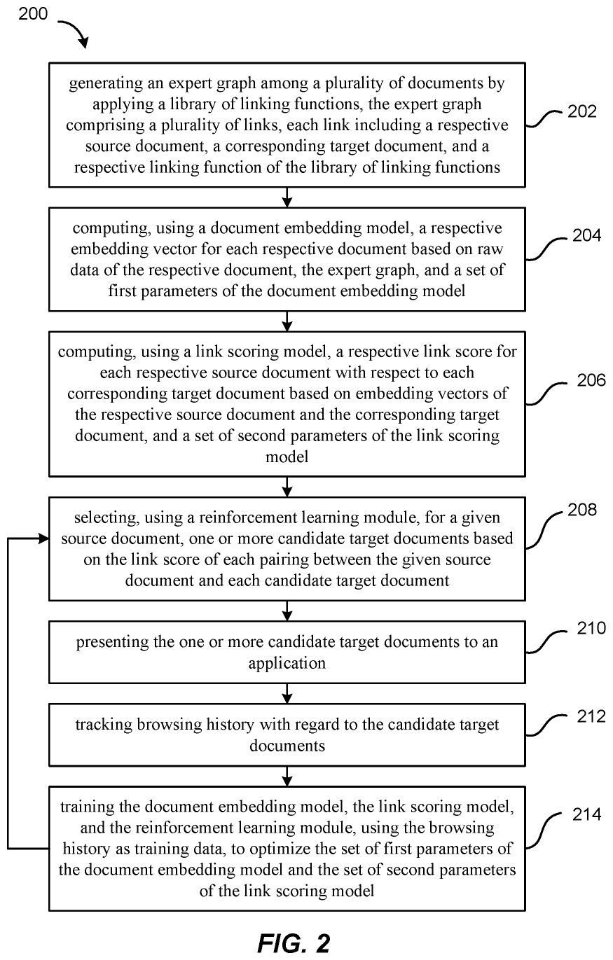

FIG. 2 is a flowchart illustrating a method for semantic graphing of heterogeneous documents according to some embodiments of the present invention.

At 202, an expert graph among a plurality of documents is generated by applying a library of linking functions. The expert graph can include a plurality of links. Each link can include a respective source document, a corresponding target document, and a respective linking function of the library of linking functions.

At 204, using a document embedding model, a respective embedding vector is computed for each respective document based on raw data of the respective document, the expert graph, and a set of first parameters of the document embedding model.

At 206, using a link scoring model, a respective link score is computed for each respective source document with respect to each corresponding target document based on embedding vectors of the respective source document and the corresponding target document, and a set of second parameters of the link scoring model.

At 208, using a reinforcement learning module, for a given source document, one or more candidate target documents are selected based on the link score of each pairing between the given source document and each candidate target document.

At 210, the one or more candidate target documents are presented to an application. Users can interact with the candidate target documents in the application. For example, a user can select a target document by clicking on a link to the target documents.

At 212, browsing history with regard to the candidate target documents are tracked. For example, how frequently each candidate target document is selected can be recorded.

At 214, the document embedding model, the link scoring model, and the reinforcement learning module are trained using the browsing history as training data by continuously repeating steps 208, 210, 212, and 214. In some embodiments, the steps 204 and 206 are also repeated, for example, when links of new documents are to be evaluated, or when the document embedding model and the link scoring model are to be re-trained after new data has been collected. Through the reinforcement learning, the set of first parameters of the document embedding model and the set of second parameters of the link scoring model can be optimized.

According to some embodiments, the document embedding model can include a graph convolutional network (GCN). GCN can include a bottom layer and one or more higher layers. For the bottom layer, an initial embedding vector can be computed for each respective document using a parameterized embedding function. For each higher layer, a next layer embedding vector can be computed for each respective document by aggregating over a lower layer embedding vectors of neighboring documents in the expert graph. Aggregating over the lower layer embedding vectors can include aggregating over the lower layer embedding vectors of neighboring documents for each respective linking function, and aggregating over all linking functions in the library of linking functions.

According to some embodiments, the link scoring model can include a neural network. The link scoring model can also compute a respective link frequency for each respective link. The link targets can be selected further based on the link frequencies in addition to the link scores. Each link score indicates a degree of relevance of the first one of the documents and a respective link target, and each link frequency indicates a frequency of the respective link target being suggested.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of embodiments of the present invention, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for generating accurate relationships among heterogeneous documents in a semantic graph for an application, the method comprising:
generating a representation for each one of a plurality of heterogeneous documents contained in an expert graph having a plurality of links;
computing a link score for each of the links of at least a first one of the documents based on the representations of the documents;
selecting, for the first one of the documents, other ones of the documents as link targets based on the link scores using reinforcement learning; and
forwarding the link targets to the application.

2. The method of claim 1, wherein:
the expert graph is generated by applying a library of linking functions to the documents, each of the links linking a source document to a target document according to the linking functions; and
generating the representation for each one of the documents is performed by a document embedding model that includes a set of first parameters and is trained to generate the representations as an n-dimensional vector of real numbers based on raw data or text of the respective document, the expert graph and the set of first parameters.

3. The method of claim 2, wherein the link scores are computed by a link scoring model
that includes a set of second parameters, and wherein the link targets are selected using a reinforcement learning module that is trained using reinforcement learning to select the link targets based on the link scores and link frequency such that the selected link targets are explorative and exploitable.

4. The method of claim 3, further comprising:
tracking browsing history with regard to the link targets; and
training the document embedding model and the link scoring model using the browsing history as training data, to optimize the set of first parameters of the document embedding model and the set of second parameters of the link scoring model.

5. The method of claim 4, wherein a reward is computed based on whether a respective target link is selected or ignored according to the browsing history, and the reward is used to train the document embedding model and the link scoring model.

6. The method of claim 4, wherein the document embedding model comprises a graph convolutional network (GCN).

7. The method of claim 6, wherein the GCN includes a bottom layer and one or more higher layers, and wherein:
for the bottom layer, an initial embedding vector is computed for each respective document using a parameterized embedding function; and
for each higher layer, a next layer embedding vector is computed for each respective document by aggregating over a lower layer embedding vectors of neighboring documents in the expert graph.

8. The method of claim 7, wherein aggregating over the lower layer embedding vectors comprises:
aggregating over the lower layer embedding vectors of neighboring documents for each respective linking function; and
aggregating over all linking functions in the library of linking functions.

9. The method of claim 4, wherein the link scoring model comprises a neural network.

10. The method of claim 1, further comprising:
computing a respective link frequency for each respective link;
wherein the link targets are selected further based on the link frequencies in addition to the link scores.

11. The method of claim 10, wherein each link score indicates a degree of relevance of the first one of the documents and a respective link target, and each link frequency indicates a frequency of the respective link target being suggested.

12. The method of claim 11, wherein the link targets are selected by optimizing a function that is proportional to the link score and inversely proportional to the link frequency.

13. The method of claim 1, further comprising accommodating a new document by:
applying the expert linking functions to the new document to extract new links between the new document and the documents; and
generating a new representation for the new document based on the representations of the documents that are stored in cache.

14. A system for generating accurate relationships among heterogeneous documents in a semantic graph for an application, the system comprising one or more hardware processors which, alone or in combination, are configured to provide for execution of the following steps:
generating a representation for each one of a plurality of heterogeneous documents contained in an expert graph having a plurality of links;
computing a link score for each of the links of at least a first one of the documents based on the representations of the documents;
selecting, for the first one of the documents, other ones of the documents as link targets based on the link scores using reinforcement learning; and
forwarding the link targets to the application.

15. A tangible, non-transitory computer-readable medium having instructions thereon, which upon execution by one or more processors, alone or in combination, provide for execution of a method comprising:
generating a representation for each one of a plurality of heterogeneous documents contained in an expert graph having a plurality of links;
computing a link score for each of the links of at least a first one of the documents based on the representations of the documents;
selecting, for the first one of the documents, other ones of the documents as link targets based on the link scores using reinforcement learning; and
forwarding the link targets to the application.
